(19) United States
(12) Patent Application Publication
(10) Pub. No.: US 2023/0138024 A1
(43) Pub. Date: May 4, 2023

(54) ADHESION PROMOTERS AND RELATED METHODS

(71) Applicant: NBD Nanotechnologies Inc., Lexington, MA (US)

(72) Inventors: Michael Martinez, Boston, MA (US); Bong June Zhang, Newton, MA (US); Miguel Galvez, Danvers, MA (US); Parfait Jean Marie Likibi, Mount Pleasant, SC (US); Perry L. Catchings, SR., Roxbury, MA (US); Fouad Salhi, Farmington, CT (US)

(73) Assignee: NBD Nanotechnologies Inc., Lexington, MA (US)

(21) Appl. No.: 17/912,002

(22) PCT Filed: Mar. 16, 2021
(86) PCT No.: PCT/US2021/022563

§ 371 Date: Sep. 15, 2022

Related U.S. Application Data
(60) Provisional application No. 62/990,010, filed on Mar. 16, 2020.

(51) Int. Cl. C09D 183/04; C08G 77/18; C09J 7/38

(52) U.S. Cl. CPC C09D 183/04; C08G 77/18; C09J 7/38; C09J 2483/00

(57) ABSTRACT

Generally described herein are adhesion promoter compositions, which can be formed, for example, via a two-step synthetic process. In some embodiments, the first step of the synthetic process involves the hydrolysis and polycondensation of an organosilane monomer compound, thereby providing a polyorganosilane intermediate compound. In certain aspects, the organosilane compound may be hydrolyzed and polycondensed in the presence of a chain extender (e.g., a co-monomer) to provide an oligomeric adhesion promoter with greater degrees of functionalization. In some embodiments, the second step of the synthetic process involves the hydrosilylation of the polyorganosilane intermediate compound with a hydro silane-containing compound, resulting in a compound of the adhesion promoter.

### TECHNICAL FIELD

Adhesion promoter compositions and related articles and methods are generally described.

### BACKGROUND

Adhesion promoters generally enhance adhesion between two materials, such as between an organic polymer and an inorganic substrate. Organic and inorganic materials may differ in their properties and characteristics, including (but not limited to) chemical reactivity, surface properties, compatibility, and coefficient of thermal expansion. An adhesion promoter may effectively act at the organic-inorganic interface to chemically and physically wet these dissimilar materials into a strong cohesive bond structure. This basic action of the adhesion promoter has allowed advances in reinforced plastics, adhesive bonding, and compatibility of different materials in a wide variety of applications. Conventional adhesion promoters, however, often lack durability.

Accordingly, improved compositions and related methods are necessary.

### SUMMARY

Described herein are adhesion promoter compositions and related articles and methods. The subject matter of the present invention involves, in some cases, interrelated products, alternative solutions to a particular problem, and/or a plurality of different uses of one or more systems and/or articles.

In one aspect, articles are provided. In some embodiments, the article comprises a substrate and an adhesion promoter layer disposed on the substrate, wherein the adhesion promoter layer comprising a compound having a branched or linear structure as in

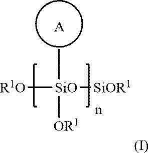

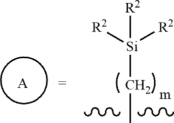

wherein:
each R¹ is the same or different and is a bond to another Si atom within the compound, or is selected from the group consisting of hydrogen, -C₁-C₆ alkyl, -C₂-C₆ alkenyl, -C₃-C₆ alkynyl, and group A;
each R² is the same or different and is group A or OR¹;
each hydrogen atom in R¹ and R² is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, -S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, NH(C₁—C₆ alkyl), —N(H)C₁—C₆ alkyl —NH₂, —N(H)C₁—C₆alkyl—Si(—OC₁—C₆ alkyl)₃, —N(R³)C₁—C₆ alkyl-N(R³)C₁—C₆ alkyl—Si(—OC₁—C₆ alkyl)₃C₁—C₆ alkyl—N(H) C₁—C₆ alkyl-NH₂, —P(C₁—C₆ alkyl)₂, —P(O)(C₁—C₆ alkyl)₂,—PO₃H₂, or —Si(—OC₁—C₆ alkyl)₃;
each R³ is selected from the group consisting of hydrogen, deuterium, —C₁—C₆ alkyl, —C₂—C₆ alkenyl, —C₂—C₆ alkynyl, —C₃—C₆ cycloalkyl, and —C₁—C₆ alkyl—O—C₁—C₆ alkyl, optionally substituted;
n is a positive integer; and
m is the same or different and is a positive integer greater than or equal to 2 and less than or equal to 20;
wherein the compound is formed by polycondensing an organosilane compound in the presence of water and hydrosilylating the product of the polycondensation.

In another aspect, methods are provided. In some embodiments, the method comprises polycondensing an organosilane compound in the presence of water, thereby providing a polyorganosilane intermediate compound and hydrosilylating the polyorganosilane intermediate compound with a hydrosilane-containing compound, thereby providing the adhesion promoter.

In some embodiments, the method comprises depositing, on a surface of a substrate, an adhesion promoter, wherein the adhesion promoter comprises a compound having a branched or linear structure as in Formula (I):

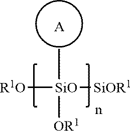

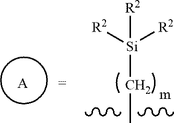

wherein:
each R¹ is the same or different and is a bond to another Si atom within the compound, or is selected from the group consisting of hydrogen, —C₁—C₆ alkyl, —C₂—C₆ alkenyl, —C₃—C₆ alkynyl, and group A;
each R² is the same or different and is group A or OR¹;
each hydrogen atom in R¹ and R² is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, —NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkylSi(—OC₁—C₆ alkyl)₃—N(H)C₁—C₆ alkyl—N(H) C₁—C₆ alkyl-NH₂, —P(C₁—C₆ alkyl)₂, —P(O)(C₁—C₆ alkyl)₂,—PO₃H₂, or —Si(—OC₁—C₆ alkyl)₃;
each R³ is selected from the group consisting of hydrogen, deuterium, —C₁—C₆ alkyl, —C₂—C₆ alkenyl, —C₂—C₆ alkynyl, —C₃—C₆ cycloalkyl, and —C₁—C₆ alkyl—O—C₁—C₆ alkyl, optionally substituted;
n is a positive integer; and
m is the same or different and is a positive integer greater than or equal to 2 and less than or equal to 20; and
curing the adhesion promoter to form the adhesion promoter layer.

In yet another aspect, compositions such as adhesion promoters are provided. In some embodiments, the composition comprises a compound having a branched or linear structure as in Formula (I):

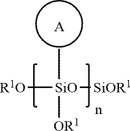

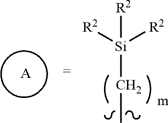

wherein:
each R¹ is the same or different and is a bond to another Si atom within the compound, or is selected from the group consisting of hydrogen, —C₁—C₆ alkyl, —C₂—C₆ alkenyl, —C₃—C₆ alkynyl, and group A;
each R² is the same or different and is group A or OR¹;
each hydrogen atom in R¹ and R² is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, -S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, —NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃;
each R³ is selected from the group consisting of hydrogen, deuterium, —C₁—C₆ alkyl, —C₂—C₆ alkenyl, —C₂—C₆ alkynyl, —C₃—C₆ cycloalkyl, and —C₁—C₆ alkyl—O—C₁—C₆ alkyl, optionally substituted;
n is a positive integer; and
m is the same or different and is a positive integer greater than or equal to 2 and less than or equal to 20;
wherein the compound is formed by polycondensing an organosilane compound in the presence of water and hydrosilylating the product of the polycondensation.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B show, according to certain embodiments, an exemplary schematic diagram of an adhesion promoter layer disposed on a substrate;

FIG. 2 shows, according to certain embodiments, molecular weights of various polyorganosilane intermediate compounds;

FIG. 3 shows, according to certain embodiments, thermogravimetric analysis (TGA) compared to ¹H-NMR analysis of the hydrolysis and polycondensation reactions of the vinyltriethoxysilane monomer at different water concentrations;

FIG. 4 shows, according to some embodiments, the relative peak intensities of each proton group of the vinyltriethoxysilane monomer and 1,2-bis(triethoxysilyl)ethane chain extender during the hydrolysis and polycondensation reactions;

FIG. 5 shows, according to some embodiments, TGA compared to ¹H-NMR analysis of the hydrolysis and polycondensation reaction of the vinyltriethoxysilane monomer and 1,2-bis(triethoxysilyl)ethane chain extender at different water concentrations.

### DETAILED DESCRIPTION

Generally described herein are adhesion promoter compositions, which can be formed, for example, via a two-step synthetic process. In some embodiments, the first step of the synthetic process involves the hydrolysis and polycondensation of an organosilane monomer compound (e.g., triethoxysilane), thereby providing a polyorganosilane intermediate compound. In certain aspects, the organosilane compound may be hydrolyzed and polycondensed in the presence of a chain extender (e.g., a co-monomer) to provide an oligomeric adhesion promoter with greater degrees of functionalization. In some embodiments, the second step of the synthetic process involves the hydrosilylation of the polyorganosilane intermediate compound with a hydrosilane-containing compound (e.g., triethoxysilane), resulting in a compound of the adhesion promoter.

Advantageously, the adhesion promoters and methods described herein may form highly chemically and mechanically robust layers (e.g., as compared to traditional adhesion promoters). In some embodiments, the hydrolysis and polycondensation of the organosilane compound is performed in the presence of water (e.g., excess water) and heat, which facilitates the hydrolysis and polycondensation reactions. Without wishing to be bound by theory, the presence of water may promote hydrolysis and/or polycondensation of the organosilane such that the resulting polymer is thermally stable and/or densely packed. The amount of water (e.g., a molar ratio of water to alkoxy groups in the starting material(s) present) used during the hydrolysis and polycondensation reactions may therefore be altered in order to finely-tune the degree of functionality of the resulting polyorganosilane intermediate compound and adhesion promoter composition final product. Other factors and conditions, such as the reaction temperatures, choice and amount of monomer and co-monomer, and/or duration of the reaction may also be selected to form adhesion promoters having desirable characteristics, as described herein. For example, in some aspects and without wishing to be bound by theory, the molecular weight distribution of a compound of the adhesion promoter composition may be directly correlated to the amount of water utilized during the hydrolysis and polycondensation reactions. In some embodiments, depending on the concentration of water utilized during the hydrolysis and polycondensation reactions, the resulting compound of the adhesion promoter may be chemically, thermodynamically, and mechanically robust. Furthermore, in some embodiments, no acid and/or base is used during the syntheses, resulting in a generally inert composition. The adhesion promoter composition may be used, for example, as a coating on a substrate with enhanced durability.

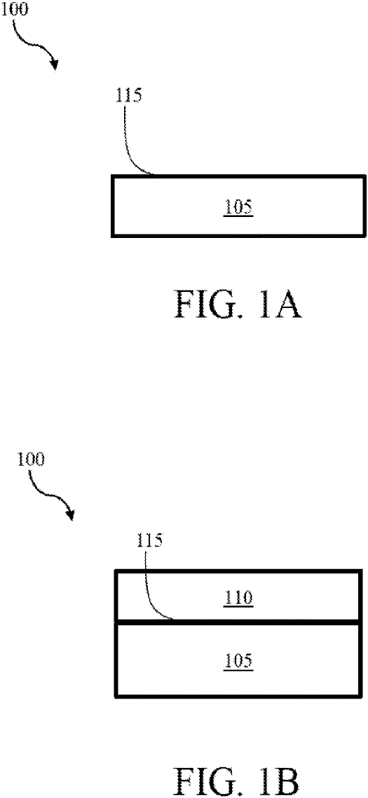

In certain embodiments, an article is described, wherein the article comprises a substrate and an adhesion promoter layer adjacent to a substrate. As used herein, when a layer is referred to as being “adjacent” to another component, it can be directly adjacent to (e.g., in contact with, disposed on) the layer, or one or more intervening layer(s) also may be present. A layer that is “directly adjacent” to another component or layer means that no intervening layer(s) is present. FIGS. 1A-1B show, according to some embodiments, an exemplary schematic diagram of an adhesion promoter layer disposed on a substrate. As illustrated in FIG. 1A, exemplary article 100 comprises substrate 105 having a surface 115. As shown in FIG. 1B, for example, article 100 comprises adhesion promoter layer 110 adjacent (e.g., disposed on) substrate 105 at surface 115. In some embodiments, the adhesion promoter layer comprises a compound having dual functionality in the molecular structure: (i) one or more central metallic atoms (e.g., silicon) that provide the compound with inorganic reactivity; and (ii) one or more organofunctional groups attached to the one or more metallic atoms through one or more organic bridges that provides the compound with organic reactivity.

In some embodiments, the adhesion promoter layer comprises a compound having a branched or linear structure as in Formula (I):

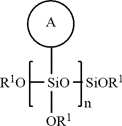

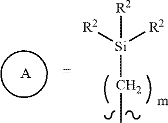

wherein:
each R¹ is the same or different and is a bond to another Si atom within the compound, or is selected from the group consisting of hydrogen, —C₁—C₆ alkyl, —C₂—C₆ alkenyl, —C₃—C₆ alkynyl, and group A;
each R² is the same or different and is group A or OR¹;
each hydrogen atom in R¹ and R² is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃;
each R³ is selected from the group consisting of hydrogen, deuterium, —C₁—C₆ alkyl, —C₂—C₆ alkenyl, —C₂—C₆ alkynyl, —C₃—C₆ cycloalkyl, and —C₁—C₆ alkyl—O—C₁—C₆ alkyl, optionally substituted;
n is a positive integer; and
m is the same or different and is a positive integer greater than or equal to 2 and less than or equal to 20.

In some embodiments, n is a positive integer and is greater than or equal to 1, greater than or equal to 2, greater than or equal to 10, greater than or equal to 20, greater than or equal to 50, greater than or equal to 100, greater than or equal 200, greater than or equal to 300, greater than or equal to 400, or greater than or equal to 450. In some embodiments, n is a positive integer and is less than or equal to 500, less than or equal to 450, less than or equal to 400, less than or equal to 300, less than or equal to 200, less than or equal to 100, less than or equal to 50, less than or equal to 20, less than or equal to 10, less than or equal to 5, or less than or equal to 2. Combinations of the above referenced ranges are also possible (e.g., n is between greater than or equal to 1 and less than or equal to 500, n is between greater than or equal to 1 and less than or equal to 300). Other ranges are also possible.

In some embodiments, each m is the same or different and is a positive integer and is greater than or equal to 2, greater than or equal to 3, greater than or equal to 4, greater than or equal to 6, greater than or equal to 8, greater than or equal to 10, greater than or equal to 12, greater than or equal to 14, greater than or equal to 16, or greater than or equal to 18. In some embodiments, each m is the same or different and is a positive integer and is less than or equal to 20, less than or equal to 18, less than or equal to 16, less than or equal to 14, less than or equal to 12, less than or equal to 10, less than or equal to 8, less than or equal to 7, less than or equal to 4, or less than or equal to 3. Combinations of the above referenced ranges are also possible (e.g., each m is between greater than or equal to 2 and less than or equal to 20, each m is between greater than or equal to 8 and less than or equal to 10). Other ranges are also possible.

In certain embodiments, the compound (e.g., of Formula (I)) is in direct contact with the substrate through one or more R² functional groups. The R² functional groups may, in some embodiments, be chemically bound to the substrate (e.g. by covalent bonds and/or non-covalent bonds, such as ionic bonds, van der Waals forces, and the like). The adhesion promoter layer may comprise any of a variety of suitable amounts of R² functional groups. For example, in certain embodiments, the adhesion promoter layer comprises greater than or equal to 100 R² functional groups, greater than or equal to 1,000 R² functional groups, greater than or equal to 5,000 R² functional groups, greater than or equal to 10,000 R² functional groups, greater than or equal to 50,000 R² functional groups, greater than or equal to 100,000 R² functional groups, or greater than or equal to 500,000 R² functional groups. In some embodiments, the adhesion promoter layer comprises less than or equal to 1,000,000 R² functional groups, less than or equal to 500,000 R² functional groups, less than or equal to 100,000 R² functional groups, less than or equal to 50,000 R² functional groups, less than or equal to 10,000 R² functional groups, less than or equal to 5,000 R² functional groups, less than or equal to 1,000 R² functional groups, or less than or equal to 500 R² functional groups. Combinations of the above recited ranges are also possible (e.g., the adhesion promoter layer comprises between greater than or equal to 100 R² functional groups and less than or equal to 1,000,000 R² functional groups, the adhesion promoter layer comprises between greater than or equal to 10,000 R² functional groups and less than or equal 50,000 R² functional groups). Other ranges are also possible. In certain embodiments, the amount of R² groups may be determined using, for example, Nuclear Magnetic Resonance (NMR) spectroscopy.

In some embodiments, the compound (e.g., of Formula (I)) comprises free —OH groups and/or alkoxy groups. In some embodiments, at least a portion of the free —OH groups and/or alkoxy groups may be in direct contact with the substrate. Without wishing to be bound by theory, the presence of free —OH groups and/or alkoxy groups may promote adhesion to the substrate. In some embodiments, the free —OH groups or alkoxy groups are present in the compound in an amount greater than or equal to 2%, greater than or equal to 5%, greater than or equal to 10%, greater than or equal to 20%, greater than or equal to 30%, greater than or equal to 40%, greater than or equal to 50%, greater than or equal to 60%, or greater than or equal to 70% of the total number of functional groups present in the compound. In some embodiments, the free —OH groups or alkoxy groups are present in the compound in an amount less than or equal to 80%, less than or equal to 70%, less than or equal to 60%, less than or equal to 50%, less than or equal to 40%, less than or equal to 30%, less than or equal to 20%, less than or equal to 10%, or less than or equal to 5% of the total number of functional groups present in the compound. Combinations of the above-referenced ranges are also possible (e.g., the free —OH groups or alkoxy groups are present in the compound in an amount between greater than or equal to 2% and less than or equal to 80%, the free —OH groups or alkoxy groups are present in the compound in an amount between greater than or equal to 30% and less than or equal to 40%). Other ranges are also possible.

In some embodiments, the adhesion promotor composition comprises a compound having a structure as in Formula (II):

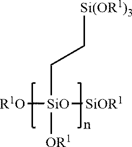

wherein:
each R¹ is the same or different and is a bond to another Si atom within the compound, or is selected from the group consisting of hydrogen, —C₁—C₆ alkyl, —C₂—C₆ alkenyl, and —C₃—C₆ alkynyl;
each hydrogen atom in R¹ is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, —NH(C₁—C₆ alkyl), —N(H)C₁—C₆ alkyl—NH₂, —N(H)C₁—C₆ alkyl—Si(—OC₁—C₆ alkyl)₃, — N(R³)C₁—C₆ alkyl—N(R³)C₁—C₆ alkyl—Si(—OC₁—C₆ alkyl)₃—N(H)C₁—C₆ alkyl—N(H)C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃;
each R³ is selected from the group consisting of hydrogen, deuterium, C₁—C₆ alkyl, C₂—C₆ alkenyl, C₂—C₆ alkynyl, C₃—C₆ cycloalkyl, and —C₁—C₆ alkyl—O—C₁—C₆ alkyl, optionally substituted; and
n is a positive integer, as described above.

According to certain embodiments, the compound of the adhesion promoter layer having a structure as in Formula (I) (or Formula (II)) is formed by polycondensing an organosilane compound in the presence of water and hydrosilylating the product of the polycondensation, as explained herein in greater detail.

In some embodiments, a method for providing an adhesion promoter is provided. In some embodiments, the method comprises hydrolyzing and/or polycondensing an organosilane compound (e.g., in the presence of water). In certain embodiments, the hydrolysis and polycondensation of the organosilane compound may occur substantially simultaneously.

Any of a variety of monomeric organosilane compounds may be utilized. In certain embodiments, for example, the organosilane compound has a structure as in:

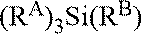

wherein:
R^{A} is the same or different and is selected from the group consisting of —OC₁—C₆ alkyl, —OC₂—C₆ alkenyl, and —OC₃—C₆ alkynyl;
R^{B} is —C₂—C₂₀ alkenyl;
each hydrogen atom in R^{A} or R^{B} is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁—C₆ alkyl)₂, —S(O)₂N(C₁—C₆ alkyl)₂, —NH₂, NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃; and
each R³ is independently deuterium, C₁—C₆ alkyl, C₂—C₆ alkenyl, C₂—C₆ alkynyl, C₃—C₆ cycloalkyl, or —C₁—C₆ alkyl—O—C₁—C₆ alkyl, wherein each hydrogen atom in C₁—C₆ alkyl is optionally substituted with hydroxyl.

In certain embodiments, the organosilane compound comprises a vinyl group. For example, in some embodiments, R^{B} in the structure (R^{A})₃Si(R^{B}) is —CH═CH₂. In some embodiments, the organosilane compound comprises one or more alkoxy groups (e.g., ethoxy groups). For example, in certain aspects, R^{A} in the structure (R^{A})₃Si(R^{B}) are ethoxy (—OCH2CH3) groups.

Non-limiting examples of suitable organosilane compounds include 3-acryloxypropyltrimethoxysilane (ACPS), 3-methacryloxypropyltrimethoxysilane (MPS), 3-glycidoxypropyltrimethoxysilane (GPS), tetrakis-(2-methacryloxyethoxy)silane (TEXS), bis-[3-(triethoxysilyl)propyl]tetrasulfide (TSEF), bis-1,2-(triethoxysilyl)ethane (BTSE), vinyltriethoxysilane (VTEOS), 1,2-bis(triethoxysilyl)ethane (BTEOS), and tris(trimethylsilyl)silane (TRIS). In an exemplary embodiment, the organosilane compound is vinyltriethoxysilane. In another exemplary embodiment, the organosilane compound is 1,2-bis(triethoxysilyl)ethane. In some embodiments, two or more organosilanes may be reacted to form a co-monomer. For example, in an exemplary embodiment, vinyltriethoxysilane and 1,2-bis(triethoxysilyl)ethane may be reacted in the presence of water to form a polyorganosilane.

In some embodiments, the organosilane compound may be hydrolyzed and polycondensed in the presence of water. Without wishing to be bound by theory, the presence of water during the hydrolyzing and polycondensing step may advantageously facilitate (e.g., drive) the hydrolysis and polycondensation of the organosilane compound. Any of a variety of suitable amounts of water may be employed during the hydrolyzing and polycondensing steps. Without wishing to be bound by theory, the amount of water during the hydrolyzing and polycondensing steps may be altered in order to adjust the functionality of the resulting polyorganosilane intermediate compound and the adhesion promoter composition.

In some embodiments, the molar ratio of water to alkoxy groups (e.g., ethoxy groups) in the starting material during the hydrolyzing and polycondensing steps is greater than or equal to 1:20, greater than or equal to 1:10, greater than or equal to 1:4, greater than or equal to 1:3, greater than or equal to 1:2, or greater than or equal to 3:4. In certain embodiments, the molar ratio of water to alkoxy groups (e.g., ethoxy groups) during the hydrolyzing and polycondensing steps is less than or equal to 20:1, less than or equal to 4:3, less than or equal to 2:1, less than or equal to 3:1, less than or equal to 4:1, or less than or equal to 10:1. Combinations of the above recited ranges are also possible (e.g., the molar ratio of water to alkoxy groups during the hydrolyzing and polycondensing steps is between greater than or equal to 1:20 and less than or equal to 20:1, the molar ratio of water to alkoxy groups during the hydrolyzing and polycondensing steps is between greater than or equal to 1:4 and less than or equal to 2:1). Other ranges are also possible.

In certain non-limiting embodiments, the molar ratio of water to alkoxy groups during the hydrolyzing and polycondensing steps is between greater than or equal to 1:2 and less than or equal to 3:1.

Without wishing to be bound by theory, in some aspects, if the amount of water during the hydrolyzing and polycondensing steps is too large (e.g., if the molar ratio of water to alkoxy groups during the hydrolyzing and polycondensing steps is greater than 20:1), then the resulting polyorganosilane intermediate compound may be an insoluble aggregate. In certain aspects, the extent of the hydrolysis and polycondensation reactions may be monitored using, for example NMR spectroscopy and TGA analysis.

In some embodiments, in addition to water, the polycondesing step is performed in the presence of one or more organic solvents. In some embodiments, for example, the polycondensing step is performed in the presence of methanol, ethanol, a glycol ether (e.g., 2-methoxyethyl ether, ethylene glycol monomethyl ether, propylene glycol monomethyl ether), and/or mixtures thereof. Other organic solvents are also possible.

The polycondensing step may be performed at any of a variety of suitable temperatures. In some embodiments, for example, the polycondensing step is performed at a temperature greater than or equal to -10° C., greater than or equal to 0° C., greater than or equal to 10° C., greater than or equal to 20° C., greater than or equal to 30° C., greater than or equal to 40° C., greater than or equal to 50° C., greater than or equal to 60° C., greater than or equal to 70° C., greater than or equal to 80° C., or greater than or equal to 90° C. In some embodiments, the polycondensing step is performed at a temperature less than or equal to 100° C., less than or equal to 90° C., less than or equal to 80° C., less than or equal to 70° C., less than or equal to 60° C., less than or equal to 50° C., less than or equal to 40° C., less than or equal to 30° C., less than or equal to 20° C., less than or equal to 10° C., or less than or equal to 0° C. Combinations of the above recited ranges are also possible (e.g., the polycondensing step is performed at a temperature between greater than or equal to -10° C. and less than or equal to 100° C., the polycondensing step is performed at a temperature between greater than or equal to 30° C. and less than or equal to 60° C.). Other ranges are also possible.

In some embodiments, it may be advantageous to perform the polycondensing step at an elevated temperature (e.g., above room temperature or above 20-22° C.). Without wishing to be bound by theory, elevated temperatures during the polycondensing step may advantageously facilitate (e.g., drive) the hydrolysis and polycondensation of the organosilane compound. In some embodiments, the elevated temperature may be a reflux temperature of the mixture of solvents utilized during the polycondensation (e.g. water and ethanol).

In certain non-limiting embodiments, the polycondensing step is performed at a temperature between greater than or equal to 70° C. and less than or equal to 100° C.

The polycondensing step may be performed at any of a variety of pH values. Without wishing to be bound by theory, it may be advantageous to perform the polycondensation of the organosilane compound at a substantially neutral pH in order to provide an adhesion promoter composition that is chemically inert and/or substantially free of acid and/or base. By contrast, in some embodiments, the synthesis of conventional adhesion promoters often occurs under acidic or basic conditions, leading to batch-to-batch variability and/or difficulty in controlling the degree of polymerization. In certain aspects, by performing the polycondensation of the organosilane compound at a substantially neautral pH using the methods described herein, the degree of functionalization of the organosilane compound is advantageously generally repeatable from batch-to-batch.

In some embodiments, the polycondensing step is performed at a pH greater than or equal to 6, greater than or equal to 6.5, greater than or equal to 7, or greater than or equal to 7.5. In certain embodiments, the polycondensing step is performed at a pH less than or equal to 8, less than or equal to 7.5, less than or equal to 7, or less than or equal to 6.5. Combinations of the above recited ranges are also possible (e.g., the polycondensing step is performed at a pH between greater than or equal to 6 and less than or equal to 8, the polycondensing step is performed at a pH between greater than or equal to 6.5 and less than or equal to 7.5). Other ranges are also possible.

The polycondensing step may be performed for any of a variety of suitable amounts of time. In some embodiments, for example, the polycondensing step is performed for a time greater than or equal to 1 hour, greater than or equal to 2 hours, greater than or equal to 5 hours, greater than or equal to 10 hours, greater than or equal to 15 hours, greater than or equal to 20 hours, greater than or equal to 25 hours, greater than or equal to 30 hours, greater than or equal to 35 hours, greater than or equal to 40 hours, or greater than or equal to 45 hours. In certain embodiments, the polycondensing step is performed for a time less than or equal to 50 hours, less than or equal to 45 hours, less than or equal to 40 hours, less than or equal to 35 hours, less than or equal to 30 hours, less than or equal to 25 hours, less than or equal to 20 hours, less than or equal to 15 hours, less than or equal to 10 hours, less than or equal to 5 hours, or less than or equal to 2 hours. Combinations of the above recited ranges are also possible (e.g., the polycondensing step is performed for a time between greater than or equal to 1 hour and less than or equal to 50 hours, the polycondensing step is performed for a time between greater than or equal to 15 hours and less than or equal to 25 hours). Other ranges are also possible.

In some embodiments, the polycondensing step is performed in the presence of a chain extender. Without wishing to be bound by theory, the presence of chain extender during the polycondensing step may provide one or more reaction products (e.g., the polyorganosilane intermediate compound, the adhesion promoter) with greater degrees of functionalization. Any of a variety of silane-based chain extenders or coupling agents may be utilized. For example, in some embodiments, the chain extender is selected from the group consisting of acryloxypropyltrimethoxysilane (ACPS), 3-methacryloxypropyltrimethoxysilane (MPS), 3-glycidoxypropyltrimethoxysilane (GPS), tetrakis-(2-methacryloxyethoxy)silane (TEXS), bis-[3-(triethoxysilyl)propyl]tetrasulfide (TSEF), bis-1,2- (triethoxysilyl)ethane (BTSE), vinyltriethoxysilane (VTEOS), 1,2-bis(triethoxysilyl)ethane (BTEOS), tris(trimethylsilyl)silane (TRIS), and 1,1,2-tris(triethoxysilyl)ethane.

Any of a variety of suitable amounts of the chain extender may be employed during the hydrolyzing and polycondensing steps. For example, in some embodiments, the molar ratio of the organosilane compound to the chain extender during the hydrolyzing and polycondensing steps is greater than or equal to 1:1, greater than or equal to 2:1, greater than or equal to 5:1, greater than or equal to 7:1, greater than or equal to 10:1, greater than or equal to 14:1, greater than or equal to 15:1, greater than or equal to 20:1, or greater than or equal to 25:1. In certain embodiments, the molar ratio of the organosilane compound to the chain extender during the hydrolyzing and polycondensing steps is less than or equal to 30:1, less than or equal to 25:1, less than or equal to 20:1, less than or equal to 15:1, less than or equal to 14:1, less than or equal to 10:1, less than or equal to 7:1, less than or equal to 5:1, or less than or equal to 2:1. Combinations of the above recited ranges are also possible (e.g., the molar ratio of the organosilane compound to the chain extender during the hydrolyzing and polycondensing steps is greater than or equal to 1:1 and less than or equal to 30:1, the molar ratio of the organosilane compound to the chain extender during the hydrolyzing and polycondensing steps is greater than or equal to 5:1 and less than or equal to 20:1). Other ranges are also possible.

In an exemplary embodiment, the molar ratio of the organosilane compound to the chain extender during the hydrolyzing and polycondensing steps is between greater than or equal to 7:1 and less than or equal to 14:1.

Without wishing to be bound by theory, in some aspects, if the amount of the chain extender during the hydrolyzing and polycondensing steps is too large (e.g., if the molar ratio of the organosilane compound to chain extender during the hydrolyzing and polycondensing steps is greater than 1:1), then the resulting polyorganosilane intermediate compound may be an insoluble aggregate.

In some embodiments wherein the polycondensing step is performed in the presence of a chain extender, the chain extender is incorporated into the polyorganosilane intermediate compound.

In certain embodiments, polycondensing the organosilane compound in the presence of water provides a polyorganosilane intermediate compound. In some embodiments the polyorganosilane intermediate compound has a structure as in Formula (III):

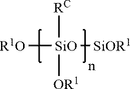

wherein:
R^{C} is —C₂—C₂₀ alkenyl;
each R¹ is the same or different and is a bond to another Si atom within the compound, or is selected from the group consisting of hydrogen, —C₁—C₆ alkyl, —C₂—C₆ alkenyl, and —C₃—C₆ alkynyl;
each hydrogen atom in R¹ is independently optionally substituted with deuterium, halogen, —OH, —CN, —OR³, —CO₂H, C(O)OR³, —C(O)NH₂, C(O)NH(C₁—C₆ alkyl), — C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, —NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃;
each R³ is independently deuterium, C₁—C₆ alkyl, C₂—C₆ alkenyl, C₂—C₆ alkynyl, C₃—C₆ cycloalkyl, or —C₁—C₆ alkyl—O—C₁—C₆ alkyl, wherein each hydrogen atom in C₁—C₆ alkyl is optionally substituted with hydroxyl; and
n is a positive integer, as described above.

In certain embodiments, the polyorganosilane intermediate compound comprises a vinyl group. For example, in some aspects, R^{C} in Formula (III) is —CH═CH₂.

According to certain embodiments, the formation of the polyorganosilane intermediate compound may be determined using, for example, Fourier-transform infrared (FT-IR) spectroscopy.

As mentioned herein, the amount of water during the hydrolyzing and polycondensing steps may alter the degree of functionality of the resulting polyorganosilane intermediate compound and adhesion promoter composition final product. In certain embodiments, for example, the number average molecular weight and/or the weight average molecular weight of the polyorganosilane intermediate compound may be directly correlated to the amount of water utilized during the hydrolyzing and polycondensing steps.

The polyorganosilane intermediate compound may have any of a variety of suitable number average molecular weights up to 1,000,000 g/mol. In some embodiments, for example, the number average molecular weight of the polyorganosilane intermediate compound is greater than or equal to 100 g/mol, greater than or equal to 200 g/mol, greater than or equal to 300 g/mol, greater than or equal to 400 g/mol, greater than or equal to 500 g/mol, greater than or equal to 550 g/mol, greater than or equal to 600 g/mol, greater than or equal to 650 g/mol, greater than or equal to 700 g/mol, greater than or equal to 750 g/mol, greater than or equal to 800 g/mol, greater than or equal to 850 g/mol, greater than or equal to 900 g/mol, greater than or equal to 950 g/mol, greater than or equal to 1,000 g/mol, greater than or equal to 1,050 g/mol, greater than or equal to 1,100 g/mol, greater than or equal to 1,050 g/mol, greater than or equal to 1,200 g/mol, greater than or equal to 1,250 g/mol, greater than or equal to 5,000 g/mol, greater than or equal to 10,000 g/mol, greater than or equal to 50,000 g/mol, greater than or equal to 100,000 g/mol, greater than or equal to 250,000 g/mol, greater than or equal to 500,000 g/mol, or greater than or equal to 750,0000 g/mol. In some embodiments, the number average molecular weight of the polyorganosilane intermediate compound is less than or equal to 1,000,000 g/mol, less than or equal to 750,000 g/mol, less than or equal to 500,000 g/mol, less than or equal to 250,000 g/mol, less than or equal to 100,000 g/mol, less than or equal to 50,000 g/mol, less than or equal to 10,000 g/mol, less than or equal to 25.000 g/mol, less than or equal to 1,300 g/mol, less than or equal to 1,250 g/mol, less than or equal to 1,200 g/mol, less than or equal to 1,150 g/mol, less than or equal to 1,100 g/mol, less than or equal to 1,050 g/mol, less than or equal to 1,000 g/mol, less than or equal to 950 g/mol, less than or equal to 900 g/mol, less than or equal to 850 g/mol, less than or equal to 800 g/mol, less than or equal to 750 g/mol, less than or equal to 700 g/mol, less than or equal to 650 g/mol, less than or equal to 600 g/mol, less than or equal to 550 g/mol, less than or equal to 500 g/mol, less than or equal to 400 g/mol, less than or equal to 300 g/mol, or less than or equal to 200 g/mol. Combinations of the above recited ranges are also possible (e.g., the number average molecular weight of the polyorganosilane intermediate compound is between greater than or equal to 500 g/mol and less than or equal to 1,300 g/mol, the number average molecular weight of the polyorganosilane intermediate compound is between greater than or equal to 800 g/mol and less than or equal to 900 g/mol, the number average molecular weight of the polyorganosilane intermediate compound is between greater than or equal to 100 g/mol and less than or equal to 1,000 ,000 g/mol). Other ranges are also possible. In certain embodiments, the number average molecular weight of the polyorganosilane intermediate compound is measured using gel permeation chromatography (GPC).

The polyorganosilane intermediate compound may have any of a variety of suitable weight average molecular weights. In some embodiments, for example, the weight average molecular weight of the polyorganosilane intermediate compound is greater than or equal to 800 g/mol, greater than or equal to 850 g/mol, greater than or equal to 900 g/mol, greater than or equal to 950 g/mol, greater than or equal to 1,000 g/mol, greater than or equal to 1,050 g/mol, greater than or equal to 1,100 g/mol, greater than or equal to 1,150 g/mol, greater than or equal to 1,200 g/mol, greater than or equal to 1,250 g/mol, greater than or equal to 1,300 g/mol, greater than or equal to 1,350 g/mol, greater than or equal to 1,400 g/mol, greater than or equal to 1,450 g/mol, greater than or equal to 1,500 g/mol, or greater than or equal to 1,550 g/mol. In some embodiments, the weight average molecular weight of the polyorganosilane intermediate compound is less than or equal to 1,600 g/mol, less than or equal to 1,550 g/mol, less than or equal to 1,500 g/mol, less than or equal to 1,400 g/mol, less than or equal to 1,450 g/mol, less than or equal to 1,300 g/mol, less than or equal to 1,250 g/mol, less than or equal to 1,200 g/mol, less than or equal to 1,150 g/mol, less than or equal to 1,100 g/mol, less than or equal to 1,050 g/mol, less than or equal to 1,000 g/mol, less than or equal to 950 g/mol, less than or equal to 900 g/mol, less than or equal to 850 g/mol, or less than or equal to 800 g/mol. Combinations of the above recited ranges are also possible (e.g., the weight average molecular weight of the polyorganosilane intermediate compound is between greater than or equal to 800 g/mol and less than or equal to 1,600 g/mol, the weight average molecular weight of the polyorganosilane intermediate compound is between greater than or equal to 900 g/mol and less than or equal to 1,100 g/mol). Other ranges are also possible. In certain embodiments, the weight average molecular weight of the polyorganosilane intermediate compound is measured using GPC.

In some embodiments, the method further comprises hydrosilylating the polyorganosilane intermediate compound with a hydrosilane-containing compound. Any of a variety of hydrosilane-containing compounds may be utilized. In some embodiments, for example, the hydrosilane-containing compound has a structure as in:

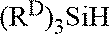

wherein:
each R^{D} is the same or different and is selected from the group consisting of —OC₁—C₆ alkyl, —OC₂—C₆ alkenyl,—OC₃—C₆ alkynyl;
each hydrogen atom in R^{D} is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃; and
each R³ is independently deuterium, C₁—C₆ alkyl, C₂—C₆ alkenyl, C₂—C₆ alkynyl, C₃—C₆ cycloalkyl, or —C₁—C₆ alkyl—O—C₁—C₆alkyl, wherein each hydrogen atom in C₁—C₆ alkyl is optionally substituted with hydroxyl.

In certain embodiments, the hydrosilane-containing compound comprises one or more alkoxy groups (e.g., ethoxy groups). For example, in certain aspects, R^{D} in the structure (R^{D})₃SiH are ethoxy (—OCH₂CH₃) groups.

In some non-limiting embodiments, the hydrosilane-containing compound is a trialkoxysilane. For example, in some aspects, the hydrosilane-containing compound is triethoxysilane.

In certain embodiments, the hydrosilylating step is performed in the presence of a catalyst. Any of a variety of catalysts may be utilized. In some aspects, for example, the catalyst is or comprises a transition metal (e.g., Pd, Pt, Ni, Rh, Ru). Non-limiting examples of suitable catalyst include Speier’s catalyst, Karstedt’s catalyst, [Rh(cod)_{2]}BF₄, [Rh(nbd)Cl]₂, Wilkinson’s catalyst, Grubb’s 1^{st} generation catalyst, Ru-based catalysts (e.g., [Ru(benzene)Cl₂]₂, [Ru(p-cymene)Cl₂]₂,or [Cp*Ru(MeCN)₃]PF₆). In an exemplary embodiment, the catalyst is or comprises Karstedt’s catalyst. Other catalysts are also possible.

In some embodiments, the hydrosilylating step is performed in the presence of one or more organic solvents. In some embodiments, for example, the polycondensing step is performed in the presence of toluene, methanol, ethanol, and/or mixtures thereof. Other organic solvents are also possible.

In certain embodiments, hydrosilylating the polyorganosilane intermediate compound with a hydrosilane-containing compound provides a compound of the adhesion promoter composition (e.g., a compound having a structure as in Formula (I) or Formula (II)).

According to certain embodiments wherein the polycondensing step is performed in the presence of a chain extender, the chain extender is incorporated into the adhesion promoter.

Certain embodiments described herein are related to a method for forming an adhesion promoter layer. In some embodiments, for example, the method comprises disposing, on a surface of a substrate, an adhesion promoter, wherein the adhesion promoter comprises a compound having a structure as in Formula (I), which is explained in further detail herein. Referring to FIGS. 1A-1B, for example, adhesion promoter 110 is disposed on surface 115 of substrate 105. In some embodiments, the method of disposing the adhesion promoter on the surface of the substrate may comprise depositing the adhesion promoter on the surface of the substrate. Any of a variety of deposition techniques may be utilized to deposit the adhesion promotor on the surface of the substrate. In some embodiments, for example, the depositing step comprises spinning (e.g., spin coating), spraying (e.g., spray coating), dipping (e.g., dip coating), wiping, chemical vapor deposition (CVD), or physical vapor deposition (PVD).

In certain embodiments, the method further comprises curing the adhesion promoter to form the adhesion promoter layer. Curing the adhesion promoter may advantageously harden the composition on the surface of the substrate. The adhesion promoter may be cured at any of a variety of temperatures. For example, in certain embodiments, the curing step comprises heating the adhesion promoter to a temperature greater than or equal to 20° C., greater than or equal to 50° C., greater than or equal to 100° C., greater than or equal to 150° C., or greater than or equal to 200° C. In some embodiments, the curing step comprises heating the adhesion promoter to a temperature less than or equal to 250° C., less than or equal to 200° C., less than or equal to 150° C., less than or equal to 100° C., or less than or equal to 50° C. Combinations of the above recited ranges are also possible (e.g., the curing step comprises heating the adhesion promoter to a temperature between greater than or equal to 20° C. and less than or equal to 250° C., the curing step comprises heating the adhesion promoter to a temperature between greater than or equal to 100° C. and less than or equal to 250° C. Other ranges are also possible.

In some embodiments, the adhesion promoter layer is cured for any of a variety of amounts of time. In some embodiments, for example, the curing step is performed for a time greater than or equal to 0.01 hours, greater than or equal to 0.1 hours, greater than or equal to 0.5 hours, greater than or equal to 1 hour, greater than or equal to 2 hours, greater than or equal to 5 hours, greater than or equal to 10 hours, greater than or equal to 24 hours, or greater than or equal to 36 hours. In certain embodiments, the curing step is performed for a time less than or equal to 48 hours, less than or equal to 36 hours, less than or equal to 24 hours, less than or equal to 10 hours, less than or equal to 5 hours, less than or equal to 2 hours, less than or equal to 1 hour, less than or equal to 0.5 hours, or less than or equal to 0.1 hours. Combinations of the above recited ranges are also possible (e.g., the curing step is performed for a time between greater than or equal to 0.01 hours and less than or equal to 48 hours, the curing step is performed for a time between greater than or equal to 1 hour and less than or equal to 10 hours). Other ranges are also possible.

According to certain embodiments, after curing the adhesion promoter layer, an additional adhesion promoter layer may be disposed (e.g., deposited using the methods described above) on a surface of the cured (e.g., first) adhesion promoter layer, thereby providing a second adhesion promoter layer. This process may be repeated, in some embodiments, to provide additional adhesion promoter layers (e.g., three adhesion promoter layers, four adhesion promoter layers, five adhesion promoter layers, and the like).

In some embodiments, the adhesion promoter layer may have any of a variety of relative humidities. For example, in certain embodiments, the adhesion promoter layer has a relative humidity greater than or equal to 1%, greater than or equal to 2%, greater than or equal to 5%, greater than or equal to 10%, greater than or equal to 15%, greater than or equal to 20%, greater than or equal to 25%, greater than or equal to 30%, greater than or equal to 40%, greater than or equal to 50%, greater than or equal to 60%, greater than or equal to 70%, greater than or equal to 80%, or greater than or equal to 90%. In some embodiments, the adhesion promoter layer has a relative humidity less than or equal to 95%, less than or equal to 90%, less than or equal to 80%, less than or equal to 70%, less than or equal to 60%, less than or equal to 50%, less than or equal to 40%, less than or equal to 30%, less than or equal to 25%, less than or equal to 20%, less than or equal to 15%, less than or equal to 10%, less than or equal to 5%, or less than or equal to 2%. Combinations of the above recited ranges are also possible (e.g., the adhesion promoter layer has a relative humidity between greater than or equal to 1% and less than or equal to 25%, the adhesion promoter layer has a relative humidity between greater than or equal to 5% and less than or equal to 10%, the adhesion promoter layer has a relative humidity between greater than or equal to 25% and less than or equal to 95%). Other ranges are also possible. In certain embodiments, the relative humidity is measured using, for example, a hygrometer.

In some embodiments, the adhesion promoter layer may have a particular thickness. In certain embodiments, for example, the thickness of the adhesion promoter layer is less than or equal to 50 nm, less than or equal to 40 nm, less than or equal to 30 nm, less than or equal to 20 nm, less than or equal to 10 nm, less than or equal to 5 nm, or less than or equal to 2 nm. In some embodiments, the thickness of the adhesion promoter layer is greater than or equal to 1 nm, greater than or equal to 2 nm, greater than or equal to 5 nm, greater than or equal to 10 nm, greater than or equal to 20 nm, greater than or equal to 30 nm, or greater than or equal to 40 nm. Combinations of the above-referenced ranges are also possible (e.g., the thickness of the adhesion promoter layer is between greater than or equal to 1 nm and less than or equal to 50 nm, the thickness of the adhesion promoter layer is greater than or equal to 1 nm and less than or equal to 20 nm). Other ranges are also possible.

The adhesion promoter layer may provide significant benefits. In some embodiments, for example, the adhesion promoter provides enhanced adhesion between two materials (e.g., an organic polymer and an inorganic substrate), especially under the effect of aerodynamic forces or mechanical motions, for example, in the case of a moving vehicle. In addition, the adhesion promoter endows strong mechanical adhesion and chemical resistance and durability due to the enhanced adhesion, especially under strong acidic/basic or organic solvent environments.

In some embodiments, the substrate comprises a material such as glass, a glass ceramic, a metal, a metal oxide, a polymer, and/or mixtures thereof. In certain embodiments, the substrate comprises a transparent material, such as glass or plastic, and is suitable for articles for transportation equipment and/or articles for building and building decorations. In certain embodiments, articles for transportation include, but are not limited to, exterior parts of an automobile, such as outer plates, window glass (e.g., windshield, side windows, rear windows, sunroof), mirrors and display panels, and interior parts of an automobile, such as instrument panels of cars, buses, trucks, ships, or aircrafts. In some aspects, articles for buildings and building decorations may be articles to be or already attached to buildingsor articles for buildings which are not attached to buildings but which are used in buildings. In some embodiments, articles for buildings include, but are not limited to, furniture or equipment, base materials (e.g., glass plates or glass windows for roofs, doors, partitions, and greenhouses), transparent plastic plates or windows to be used instead of or in addition to glass, and wall materials (e.g., ceramics, cement, etc.).

In certain embodiments, the method may further comprise activating the surface of the substrate. In some aspects, for example, the surface of the substrate is activated by exposing the surface to a plasma of at least one gas selected from the group consisting of inert gases, Ar, Ne, He, N₂, O₂, H₂O, and/or mixtures thereof. In some embodiments, the surface of the substrate is activated by mechanically treating the surface with a metal oxide or acid etching (e.g., with hydrofluoric acid or hydrochloric acid, for example).

In certain embodiments, a topcoat layer may be disposed on the adhesion promoter layer. In some embodiments, the composition of the topcoat layer is dependent on factors such as the application or industry for which the article being manufactured will be used, the type of substrate to which the topcoat is being applied, the chemical and/or physical characteristics desired for the coated surface, and the like. In some embodiments, for example, it may be desirable to prepare a coated substrate having an omniphobic coating, such as on a glass substrate, for use in, for example, the automotive field as a windshield. In such an exemplary embodiment, the topcoat layer (e.g., omniphobic coating) may comprise a fluorinated alkyl silane, an alkyl silane, a functionalized alkyl silane, tetraethyl orthosilicate, a fluorine-adhesion promoter, a thiol, a hydroxylated alkyl chain, a phosphonate monolayer, an amine monolayer, and/or mixtures thereof.

In some embodiments, the topcoat layer may comprise a polymeric material comprising reactive functionalities compatible with the adhesion promoter layer. For example, in certain embodiments, a substrate may comprise a polymer coating, such as on a metal, metal oxide, or polymer substrate for use in, for example, the automotive field as a car window or windshield. In certain exemplary embodiments, the topcoat layer, for example, comprises a urethane, epoxy, acrylate, polyvinylidene fluoride, polytetrafluoroethylene, polyester, polyethylene, polyvinyl acrylic, polyetheretherketone, polypropylene, polystyrene, polyamide, polyethylene terephthalate, polyfluorene vinylene, acrylonitrile butadiene styrene, polphenylene sulfide, polysulfone, polyoxymethylene, polyetherketone, nylon, and/or mixtures thereof.

Definitions of specific functional groups and chemical terms are described in more detail below. For purposes of this invention, the chemical elements are identified in accordance with the Periodic Table of the Elements, CAS version, Handbook of Chemistry and Physics, 75th Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

It will be appreciated that the compounds, as described herein, may be substituted with any number of substituents or functional moieties. In general, the term “substituted” whether preceded by the term “optionally” or not, and substituents contained in formulas of this invention, refer to the replacement of hydrogen radicals in a given structure with the radical of a specified substituent. When more than one position in any given structure may be substituted with more than one substituent selected from a specified group, the substituent may be either the same or different at every position. As used herein, the term “substituted” is contemplated to include all permissible substituents of organic compounds. In a broad aspect, the permissible substituents include acyclic and cyclic, branched and unbranched, carbocyclic and heterocyclic, aromatic and nonaromatic substituents of organic compounds. For purposes of this invention, heteroatoms such as nitrogen may have hydrogen substituents and/or any permissible substituents of organic compounds described herein which satisfy the valencies of the heteroatoms. Furthermore, this invention is not intended to be limited in any manner by the permissible substituents of organic compounds. Combinations of substituents and variables envisioned by this invention are preferably those that result in the formation of stable compounds useful in the anti-fog and anti-fouling applications. The term “stable”, as used herein, preferably refers to compounds which possess stability sufficient to allow manufacture and which maintain the integrity of the compound for a sufficient period of time to be detected and preferably for a sufficient period of time to be useful for the purposes detailed herein.

As used herein, “alkyl” refers to a radical of a straight-chain or branched saturated hydrocarbon group having from 1 to 10 carbon atoms (“C_{1—}C₁₀ alkyl”). In some embodiments, an alkyl group has 1 to 9 carbon atoms (“C_{1—}C₉ alkyl”). In some embodiments, an alkyl group has 1 to 8 carbon atoms (“C_{1—}C₈ alkyl”). In some embodiments, an alkyl group has 1 to 7 carbon atoms (“C_{1—} C₇ alkyl”). In some embodiments, an alkyl group has 1 to 6 carbon atoms (“C_{1—}C₆ alkyl”). In some embodiments, an alkyl group has 1 to 5 carbon atoms (“C_{1—}C₅ alkyl”). In some embodiments, an alkyl group has 1 to 4 carbon atoms (“C_{1—}C₄ alkyl”). In some embodiments, an alkyl group has 1 to 3 carbon atoms (“C_{1—}C₃ alkyl”). In some embodiments, an alkyl group has 1 to 2 carbon atoms (“C_{1—}C₂ alkyl”). In some embodiments, an alkyl group has 1 carbon atom (“C₁ alkyl”). In some embodiments, an alkyl group has 2 to 6 carbon atoms (“C_{2—}C₆ alkyl”). Examples of C₁—C₆ alkyl groups include methyl (C₁), ethyl (C₂), n-propyl (C₃), isopropyl (C₃), n-butyl (C₄), tert-butyl (C₄), sec-butyl (C₄), iso-butyl (C₄), n-pentyl (C₅), 3-pentanyl (C₅), amyl (C₅), neopentyl (C₅), 3-methyl-2-butanyl (C₅), tertiary amyl (C₅), and n-hexyl (C₆). Additional examples of alkyl groups include n-heptyl (C₇), n-octyl (Cs) and the like. Unless otherwise specified, each instance of an alkyl group is independently unsubstituted (an “unsubstituted alkyl”) or substituted (a “substituted alkyl”) with one or more substituents. In certain embodiments, the alkyl group is an unsubstituted C₁—C₁₀ alkyl (e.g., —CH₃). In certain embodiments, the alkyl group is a substituted C₁—C₁₀ alkyl.

As used herein, the term “alkenyl” includes a radical of a straight-chain or branched saturated hydrocarbon group having from 2 to 10 carbon atoms, and also includes at least one carbon-carbon double bond. It will be understood that in certain embodiments, alkenyl may be advantageously of limited length, including C₂—C₁₀, C₂—C₉, C₂—C₈, C₂—C₇, C₂—C₆, C₂—C₅, C₂—C₄, and C₂—C₃.

As used herein, the term “alkynyl” includes a radical of a straight-chain or branched saturated hydrocarbon group having from 3 to 10 carbon atoms, and also includes at least one carbon-carbon triple bond. It will be understood that in certain embodiments, alkenyl may be advantageously of limited length, including C₃—C₁₀, C₃—C₉, C₃—C₈, C₃—C₇, C₃—C₆, C₃—C₅, and C₃—C₄.

It should be understood that affixing the suffix “-ene” to a group indicates the group is a divalent moiety, (e.g., alkylene is the divalent moiety of alkyl, heteroalkylene is the divalent moiety of heteroalkyl). Affixing the suffice “-yne” to a group indicates the group is trivalent moiety (e.g., alkylyne is the trivalent moiety of alkyl, heteroalkylyne is the trivalent moiety of heteroalkyl).

As used herein, the term “halogen” refers to fluorine (fluoro, —F), chlorine (chloro, —Cl), bromine (bromo, —Br), or iodine (iodo, —I).

As used herein, the term “hydroxy” or “hydroxyl” refers to an —OH group.

As used herein, the term “alkoxy” refers to an —O—(alkyl) or an —O—(cycloalkyl) group. Representative alkoxy group examples include, but are not limited to, methoxy, ethoxy, propoxy, butoxy, cyclopropyloxy, cyclobutyloxy, cyclopentyloxy, and the link.

As understood from the above, alkyl, alkylene, and alkylyne groups, as defined herein, are, in certain embodiments, optionally substituted. Optionally substituted refers to a group which may be substituted or unsubstituted (e.g., “substituted” or “unsubstituted” alkyl). In general, the term “substituted” means that at least one hydrogen present on a group is replaced with a permissible substituent (e.g., a substituent which upon substitution results in a stable compound, such as a compound which does not spontaneously undergo transformation such as by rearrangement, cyclization, elimination, or other reaction).

Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds, and includes any of the substituents described herein that results in the formation of a stable compound. The present invention contemplates any and all such combinations in order to arrive at a stable compound. For purposes of this invention, heteroatoms such as nitrogen may have hydrogen substituents and/or any suitable substituent as described herein which satisfy the valencies of the heteroatoms and results in the formation of a stable moiety.

The following examples are intended to illustrate certain embodiments of the present invention, but do not exemplify the full scope of the invention.

### Example 1

The following example describes the synthesis of a compound of the adhesion promoter composition. The first step of the two-part synthetic process was the hydrolysis of the alkoxy end groups of the vinyltriethoxysilane monomer to hydroxyl end groups, thereby liberating ethanol. Condensation occurred following the hydrolysis, resulting in a polymeric polyorganosilane intermediate compound and water.

To perform the reactions, 20 g of vinyltriethoxysilane, 50 mL of 200 proof ethanol (anhydrous), and 2.8 mL of deionized water were charged to a 100 mL round bottom flask equipped with a reflux condenser. The solution was heated to reflux while mixing, and held for 20 hours. The reaction mixture was then rotary evaporated under vacuum at 45-55° C. to remove ethanol and water, resulting in 10.9 g of the polyorganosilane intermediate compound. As shown in Table 1, the amount of water charged to the reaction was varied to modify the extent of the hydrolysis and condensation of the polyorganosilane intermediate compound.

TABLE 1

Amounts of vinyltriethoxysilane and water charges and yields.

| Example | Vinyltriethoxysilane (g) | Water (mL) | Molar ratio of water : ethoxy groups | Yield (g) |
|---|---|---|---|---|
| 1 | 20 | 2.8 | 1.0 : 2.0 | 10.9 |
| 2 | 20 | 5.68 | 1.0 : 1.0 | 10.4 |
| 3 | 20 | 7.57 | 1.3 : 1.0 | 10.8 |
| 4 | 20 | 11.36 | 2.0 : 1.0 | 10.0 |
| 5 | 20 | 17.04 | 3.0 : 1.0 | 9.8 |
| 6 | 15 | 21.3 | 5.0 : 1.0 | 7.0 |
| 7 | 15 | 29.9 | 7.0 : 1.0 | 7.0 |

In the second step of the two-part synthetic process, the isolated polyorganosilane intermediate compound underwent hydrosilylation, wherein triethoxysilane was added across the vinyl bond of the polyorganosilane intermediate compound.

### Example 2

The following example describes the hydrolysis and polycondensation of an organosilane compound in the presence of a chain extender. The polyorganosilane intermediate compound (and the resulting compound of the adhesion promoter composition) were modified by the addition of a chain extender (e.g., co-monomer) during the hydrolysis and polycondensation of the vinyltriethoxysilane monomer. The chain extender 1,2-bis(triethoxysilyl)ethane was utilized. An excess amount of the vinyltriethoxysilane monomer to chain extender was incorporated to allow for the formation of a liquid product. If the amount of the chain extender is too large, an insoluble solid final product may result.

To perform the reactions, 20 g of vinyltriethoxy silane, 2.66 g 1,2-bis(triethoxysilyl)ethane, 50 mL of 200 proof ethanol (anhydrous), and 0.81 mL of deionized water were charged to a 100 mL round bottom flask equipped with a reflux condenser. The solution was heated to reflux while mixing, and held for 20 hours. The reaction mixture was then rotary evaporated under vacuum at 45-55° C. to remove ethanol and water, resulting in 17.0 g of polyvinyl siloxane. As shown in Table 2, the amount of water charged to the reaction was varied to modify the extent of the hydrolysis and condensation of the polyorganosilane intermediate compound.

TABLE 2

Amounts of vinyltriethoxysilane, bis(triethoxysilyl)ethane, and water charges and yields.

| Example | Vinyltriethoxysilane (g) | Bis(triethoxysilyl)ethane (g) | Water (mL) | Water : Ethoxy | Yield (g) |
|---|---|---|---|---|---|
| 8 | 20 | 2.66 | 0.81 | 1.0 : 8.0 | 17.0 |
| 9 | 20 | 2.66 | 1.08 | 1.0 : 6.0 | 16.8 |
| 10 | 20 | 2.66 | 1.62 | 1.0 : 4.0 | 19.7 |
| 11 | 20 | 2.66 | 2.16 | 1.0 : 3.0 | 13.9 |
| 12 | 20 | 2.66 | 6.49 | 1.0 : 1.0 | 12.4 |
| 13 | 20 | 2.66 | 8.43 | 1.3 : 1.0 | 12.0 |
| 14 | 20 | 2.66 | 12.97 | 2.0 : 1.0 | 11.7 |
| 15 | 15 | 1.99 | 24.3 | 5.0 : 1.0 | 8.2 |
| 16 | 20 | 2.66 | 1.62 | 1.0 : 4.0 | 14.9 |
| 17 | 20 | 2.66 | 2.16 | 1.0 : 3.0 | 15.1 |
| 18 | 20 | 2.66 | 3.24 | 1.0 : 2.0 | 15.3 |
| 19 | 40 | 5.32 | 12.96 | 1.0 : 1.0 | 24.3 |
| 20 | 20 | 5.32 | 7.29 | 1.0 : 1.0 | 14.5 |

To perform the hydrosilyation reaction, 14.9 g of the polyorganosilane intermediate compound (i.e., Example 16), 19.0 g of triethoxysilane, and 50 mL of toluene were charged to a 100 mL flask. The reaction mixture was subjected to an argon sparge and heated to 40° C. Once at 40° C., the mixture was deoxygenated. After 30 minutes, 0.2 mL of a Pt⁽⁰⁾ complex was added and the reaction mixture was heated to 80° C. while maintaining the argon sparge. The reaction was held at 80° C. for 20 hours. After the 20 hour hold, the mixture was filtered through celite and then rotary evaporated to remove toluene, resulting in 28.3 g of the adhesion promoter. As shown in Table 3, the amount of the polyorganosilane intermediate compound and triethoxysilane charged to the reaction was varied.

TABLE 3

Amounts of polyorganosilane intermediate compound and triethoxysilane charges and yields.

| Example | Polyorganosilane intermediate compound (g) | Triethoxysilane (g) | Yield (g) |
|---|---|---|---|
| 16 | 14.9 | 19 | 28.3 |
| 17 | 15.1 | 19 | 26.2 |
| 18 | 15.3 | 19 | 24.9 |
| 19 | 24.3 | 38 | 43.7 |
| 20 | 14.5 | 19 | 24.4 |

### Example 3

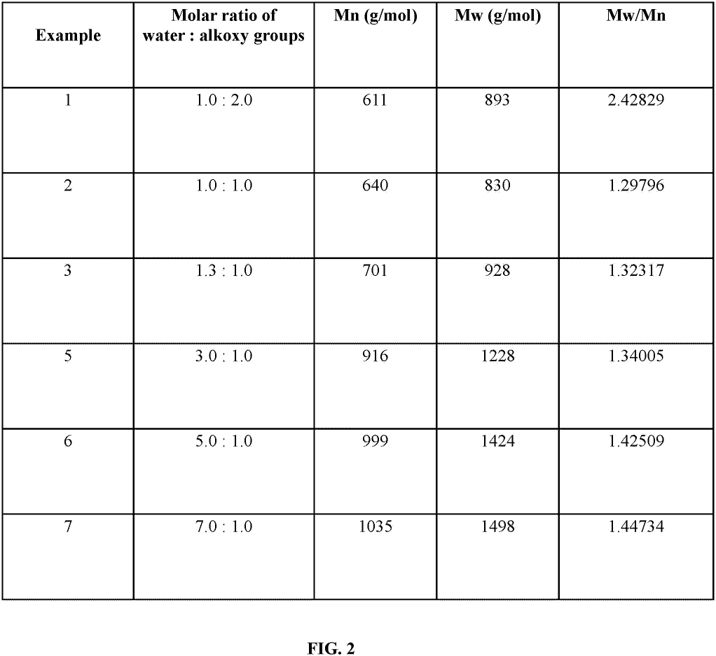

The following example describes the amount of water utilized during the hydrolysis and polycondensation of an organosilane compound. The molecular weight of the polyorganosilane intermediate compound used to make a compound of the adhesion promoter is controlled by balancing the molar ratio of water to alkoxy groups of the organosilane compound. As the amount of water increases, the final molecular weight increases, as noted by the shift to the right of the molecular weight distributions, and as shown in FIG. 2.

### Example 4

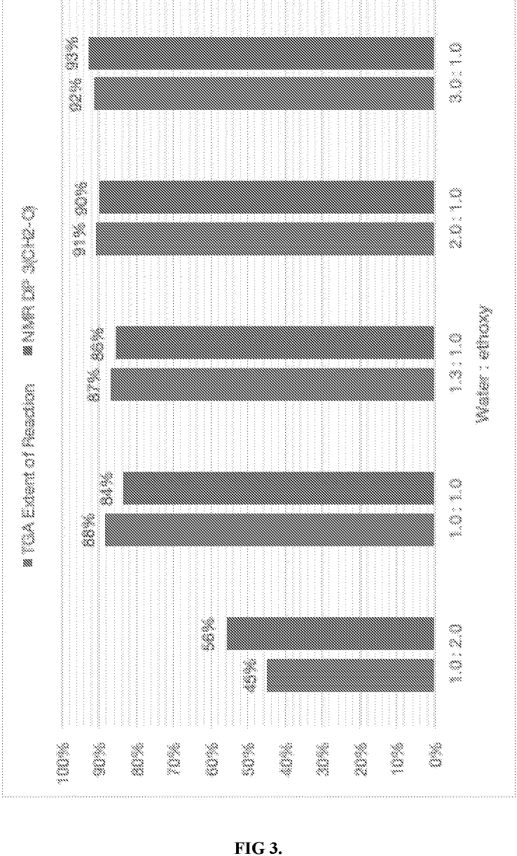

The following example describes a TGA analysis used to determine the extent of the hydrolysis and polycondensation reactions. The trend observed in the ¹H—NMR analysis was compared to TGA, as shown in FIG. 3. The comparison of TGA to ¹H— NMR data indicates that the higher the water content in the hydrolysis reaction, the higher the degree of polymerization and the lower amount of unreacted vinyltriethoxysilane or volatile components. At lower concentrations of water, for example, volatile product weight loss was more than half. It is possible that most of the products generated from the lower water to alkoxy molar ratios might be lower molecular weight dimers or oligomers, which could be volatile or decomposed at lower temperature (< 200° C.). As the water concentrations increased, the volatile product weight loss decreased. The TGA trend is well-matched with the ¹H—NMR analysis.

### Example 5

The following example describes the analysis of the extent of the hydrolysis and polycondensation reactions in the presence of a chain extender (e.g., co-monomer). A chain extender, such as 1,2-bis(triethoxysilyl)ethane, was added during the hydrolysis and condensation reactions of vinyltriethoxysilane. 1,2-bis(triethoxysilyl)ethane consists of two main functional groups (i.e., ethoxy and ethane groups).

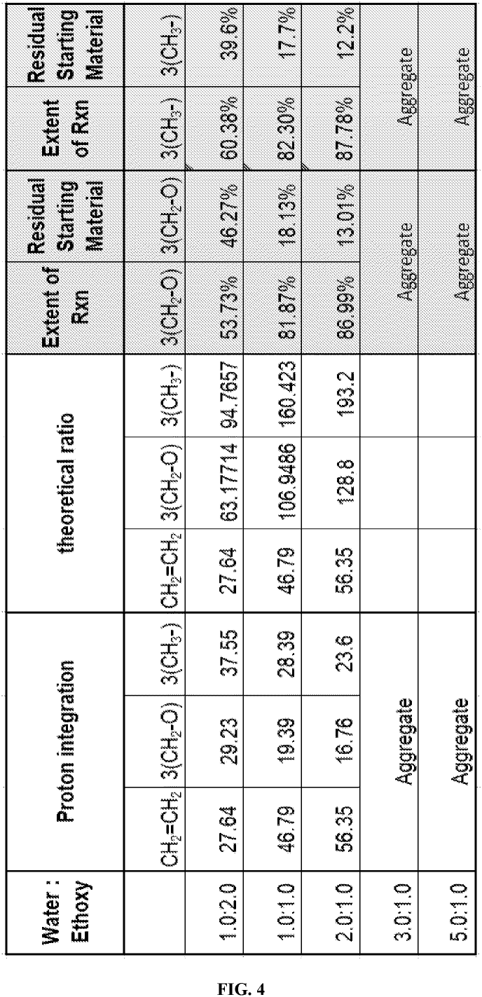

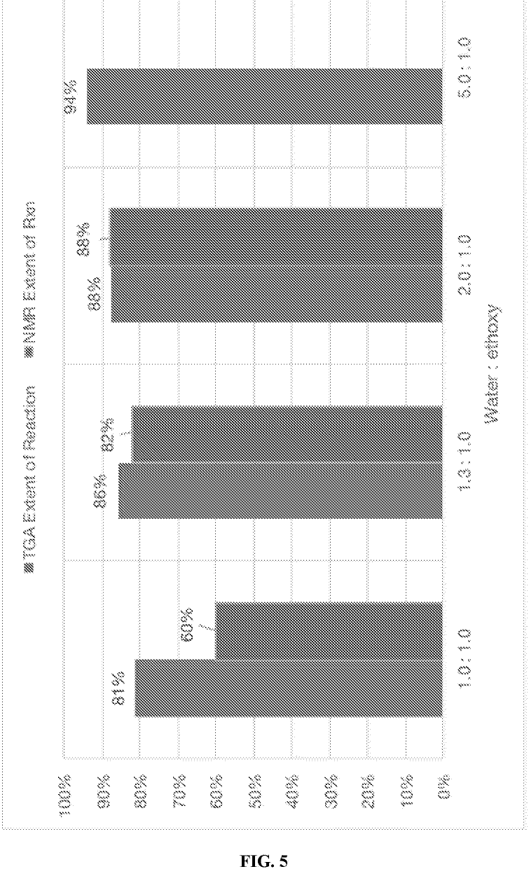

The molar ratio of the vinyltriethoxysilane monomer to the 1,2-bis(triethoxysilyl)ethane chain extender in the reaction mixtures was 14:1. The hydrolysable groups (e.g., ethoxy, CH₃CH2OSi) of the vinyltriethoxysilane monomer and the 1,2-bis(triethoxysilyl)ethane chain extender were converted into alcohols (silanol, HO-Si) via hydrolysis and subsequently siloxanes (O—Si—O) via condensation as the reaction proceeds. The summary of the extent of polyvinyl siloxane and residual amount of starting material is listed in FIG. 4. At the lower concentrations of water, such as a molar ratio of water : ethoxy of 1:2, the reactivity of the products is 54-60%. It is notable that if the ratio of water : ethoxy is more than 1:1, substantially enhanced reactivity (54% → 82%) was observed. This discrete jump in the reactivity is quite similar to what is observed for the vinyltriethoxysilane monomer alone. It is possible that as the water content is beyond threshold, silanols begin self-condensation (HO—Si + HO—Si → O—Si—O + H₂O) and the by-product water subsequently increases water concentration in the reaction and triggers hydrolysis. The trend observed in the ¹H—NMR analysis was compared to TGA data, as shown in FIG. 5. Overall, the extent of reaction trends seen in NMR and TGA are aligned with each other.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An article, comprising:
a substrate; and
an adhesion promoter layer disposed on the substrate, wherein the adhesion promoter layer comprises a compound having a branched or linear structure as in 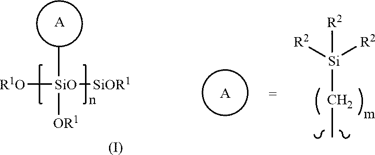
wherein:
each R¹ is the same or different and is a bond to another Si atom within the compound, or is selected from the group consisting of hydrogen, -C₁-C₆ alkyl, -C₂-C₆ alkenyl, -C₃-C₆ alkynyl, and group A;
each R² is the same or different and is group A or OR¹;
each hydrogen atom in R¹ and R² is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃;
each R³ is selected from the group consisting of hydrogen, deuterium, —C₁—C₆ alkyl, —C₂—C₆ alkenyl, —C₂—C₆ alkynyl, —C₃—C₆ cycloalkyl, and —C₁—C₆ alkyl—O—C₁—C₆ alkyl, optionally substituted;
n is a positive integer; and
m is the same or different and is a positive integer greater than or equal to 2 and less than or equal to 20;
wherein the compound is formed by polycondensing an organosilane compound in the presence of water and hydrosilylating the product of the polycondensation.

2. The article of claim 1, wherein the adhesion promotor layer comprises a compound having a structure as in Formula (II): 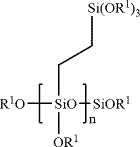
wherein:
each R¹ is the same or different and is a bond to another Si atom within the compound, or is selected from the group consisting of hydrogen, —C₁—C₆ alkyl, —C₂—C₆ alkenyl, and —C₃—C₆ alkynyl;
each hydrogen atom in R¹ is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁-C₆ alkyl)₂, —NH₂, —NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl-N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃;
each R³ is selected from the group consisting of hydrogen, deuterium, C₁—C₆ alkyl, C₂—C₆ alkenyl, C₂—C₆ alkynyl, C₃—C₆ cycloalkyl, and —C₁—C₆ alkyl—O—C₁—C₆ alkyl, optionally substituted; and
n is a positive integer.

3. The article of any one of the preceding claims, wherein the substrate comprises a material selected from the group consisting of glass, a glass ceramic, a metal oxide, or a polymer.

4. The article of any one of the preceding claims, wherein the adhesion promoter layer has a relative humidity of greater than or equal to 10%.

5. The article of any one of claims 1-4, further comprising a topcoat layer disposed on the adhesion promotor layer.

6. The article of any one of claims 1-5, wherein the compound comprises reactive species groups in an amount between 2% and 80% of the total number of functional groups present in the compound.

7. The article of any one of claims 1-6, wherein the compound is in direct contact with the substrate through one or more R² functional groups.

8. A method for providing an adhesion promoter, comprising:
polycondensing an organosilane compound in the presence of water, thereby providing a polyorganosilane intermediate compound; and
hydrosilylating the polyorganosilane intermediate compound with a hydrosilane-containing compound, thereby providing the adhesion promoter.

9. The method of claim 8, wherein the organosilane compound has a structure as in: 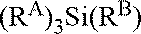
wherein:
R^{A} is the same or different and is selected from the group consisting of —OC₁—C₆ alkyl, —OC₂—C₆ alkenyl, and —OC₃—C₆ alkynyl;
R^{B} is —C₂—C₂₀ alkenyl;
each hydrogen atom in R^{A} or R^{B} is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁—C₆alkyl)₂, —S(O)₂N(C₁—C₆ alkyl)₂, —NH₂, NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃; and
each R³ is independently deuterium, C₁—C₆ alkyl, C₂—C₆ alkenyl, C₂—C₆ alkynyl, C₃—C₆ cycloalkyl, or —C₁—C₆ alkyl—O—C₁—C₆ alkyl, wherein each hydrogen atom in C₁—C₆ alkyl is optionally substituted with hydroxyl.

10. The method of any one of claims 8-9, wherein the organosilane compound comprises a vinyl group.

11. The method of any one of claims 8-10, wherein the organosilane compound comprises one or more alkoxy groups.

12. The method of any one of claims 8-11, wherein the organosilane compound comprises one or more ethoxy groups.

13. The method of any one of claims 8-12, wherein the organosilane compound is vinyltriethoxysilane.

14. The method of any one of claims 8-13, wherein the molar ratio of water to alkoxy groups during the polycondensing step is greater than or equal to 1:20 and less than or equal to 20:1.

15. The method of any one of claims 8-14, wherein the polycondensing step is performed at a temperature between greater than or equal to -10° C. and less than or equal to 100° C.

16. The method of any one of claims 8-15, wherein the polycondensing step is performed at a pH between greater than or equal to 6 and less than or equal to 8.

17. The method of any one of claims 8-16, wherein the polycondensing step is performed in the presence of a chain extender.

18. The method of claim 17, wherein the molar ratio of the organosilane compound to the chain extender during the polycondensing step is greater than or equal to 1:1 and less than or equal to 30:1.

19. The method of any one of claims 17-18, wherein the chain extender is 1,2-bis(triethoxysilyl)ethane or 1,1,2-tris(triethoxysilyl)ethane.

20. The method of any one of claims 8-19, wherein the polyorganosilane intermediate compound has a structure as in Formula (III): 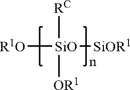
wherein:
R^{C} is —C₂—C₂₀ alkenyl;
each R¹ is the same or different and is a bond to another Si atom within the compound, or is selected from the group consisting of hydrogen, —C₁—C₆ alkyl, —C₂—C₆ alkenyl, and —C₃—C₆ alkynyl;
each hydrogen atom in R¹ is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, —NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃;
each R³ is independently deuterium, C₁—C₆ alkyl, C₂—C₆ alkenyl, C₂—C₆ alkynyl, C₃—C₆ cycloalkyl, or —C₁—C₆ alkyl—O—C₁—C₆ alkyl, wherein each hydrogen atom in C₁—C₆ alkyl is optionally substituted with hydroxyl; and
n is a positive integer.

21. The method of any one of claims 8-20, wherein the polyorganosilane intermediate compound comprises a vinyl group.

22. The method of any one of claims 8-21, wherein the chain extender is incorporated into the polyorganosilane intermediate compound.

23. The method of any one of claims 8-22, wherein the hydrosilane-containing compound has a structure as in: 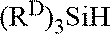
wherein:
each R^{D} is the same or different and is selected from the group consisting of —OC₁—C₆ alkyl, —OC₂—C₆ alkenyl,—OC₃—C₆ alkynyl, or —Si(—OC₀—C₆ alkyl)₃ —Si(OC₀—C₆ alkenyl)₃, and —Si(OC₀—C₆ alkynyl)₃;
each hydrogen atom in R^{D} is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl-N(R³)C₁—C₆ alkyl—Si(—OC₁—C₆ alkyl)₃—N(H)C₁—C₆ alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃; and
each R³ is independently deuterium, C₁—C₆ alkyl, C₂—C₆ alkenyl, C₂—C₆ alkynyl, C₃—C₆ cycloalkyl, or —C₁—C₆ alkyl—O—C₁—C₆alkyl, wherein each hydrogen atom in C₁—C₆ alkyl is optionally substituted with hydroxyl.

24. The method of any one of claims 8-23, wherein the hydrosilane-containing compound is trialkoxysilane.

25. The method of any one of claims 8-24, wherein the hydrosilane-containing compound is triethoxysilane.

26. The method of any one of claims 8-25, wherein the hydrosilylating step is performed in the presence of a catalyst.

27. The method of 26, wherein the catalyst is Karstedt’s catalyst.

28. The method of any one of claims 8-27, wherein the adhesion promoter comprises a compound having a linear or branched structure as in Formula (I): 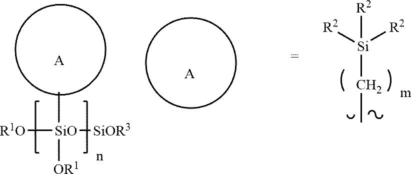
wherein:
each R¹ is the same or different and is a bond to another Si atom within the compound, or is selected from the group consisting of hydrogen, —C₁—C₆ alkyl, —C₂—C₆ alkenyl, —C₃—C₆ alkynyl, and group A;
each R² is the same or different and is group A or OR¹;
each hydrogen atom in R¹ and R² is independently optionally substituted with deuterium, halogen, —OH, —CN, —OR³, —CO₂H, C(O)OR³, —C(O)NH₂, C(O)NH(C₁-C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, —NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃;
each R³ is selected from the group consisting of hydrogen, deuterium, —C₁—C₆ alkyl, —C₂—C₆ alkenyl, —C₂—C₆ alkynyl, —C₃—C₆ cycloalkyl, and —C₁—C₆ alkyl—O—C₁—C₆ alkyl, optionally substituted;
n is a positive integer; and
m is the same or different and is a positive integer greater than or equal to 2 and less than or equal to 20.

29. The method of any one of claims 8-28, wherein the chain extender is incorporated into the adhesion promoter.

30. The method of any one of claims 8-29, wherein the adhesion promotor comprises a compound having a structure as in Formula (II): 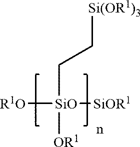
wherein:
each R¹ is the same or different and is a bond to another Si atom within the compound, or is selected from the group consisting of hydrogen, —C₁—C₆ alkyl, —C₂—C₆ alkenyl, and —C₃—C₆ alkynyl;
each hydrogen atom in R¹ is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, —NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃;
each R³ is selected from the group consisting of hydrogen, deuterium, C₁—C₆ alkyl, C₂—C₆ alkenyl, C₂—C₆ alkynyl, C₃—C₆ cycloalkyl, and —C₁—C₆ alkyl—O—C₁—C₆ alkyl, optionally substituted; and
n is a positive integer.

31. An adhesion promoter composition, comprising:
a compound having a branched or linear structure as in Formula (I): 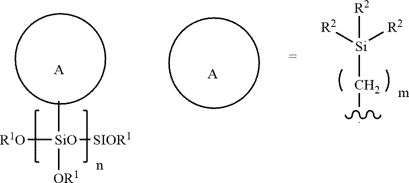
wherein:
each R¹ is the same or different and is a bond to another Si atom within the compound, or is selected from the group consisting of hydrogen, —C₁—C₆ alkyl, —C₂—C₆ alkenyl, —C₃—C₆ alkynyl, and group A;
each R² is the same or different and is group A or OR¹;
each hydrogen atom in R¹ and R² is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃;
each R³ is selected from the group consisting of hydrogen, deuterium, —C₁—C₆ alkyl, —C₂—C₆ alkenyl, —C₂—C₆ alkynyl, —C₃—C₆ cycloalkyl, and —C₁—C₆ alkyl—O—C₁—C₆ alkyl, optionally substituted;
n is a positive integer; and
m is the same or different and is a positive integer greater than or equal to 2 and less than or equal to 20;
wherein the compound is formed by polycondensing an organosilane compound in the presence of water and hydrosilylating the product of the polycondensation.

32. The adhesion promotor composition of claim 31, wherein the adhesion promotor composition comprises a compound having a structure as in Formula (II): 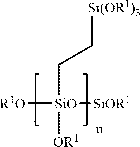
wherein:
each R¹ is the same or different and is a bond to another Si atom within the compound, or is selected from the group consisting of hydrogen, —C₁—C₆ alkyl, —C₂—C₆ alkenyl, and —C₃—C₆ alkynyl;
each hydrogen atom in R¹ is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, —NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃;
each R³ is selected from the group consisting of hydrogen, deuterium, C₁—C₆ alkyl, C₂—C₆ alkenyl, C₂—C₆ alkynyl, C₃—C₆ cycloalkyl, and —C₁—C₆ alkyl—O—C₁—C₆ alkyl, optionally substituted; and
n is a positive integer.

33. A method for forming an adhesion promoter layer, comprising:
depositing, on a surface of a substrate, an adhesion promoter, wherein the adhesion promoter comprises a compound having a branched or linear structure as in 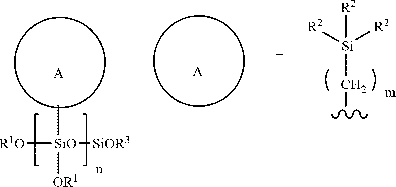
wherein:
each R¹ is the same or different and is a bond to another Si atom within the compound, or is selected from the group consisting of hydrogen, -C₁-C₆ alkyl, -C₂-C₆ alkenyl, -C₃-C₆ alkynyl, and group A;
each R² is the same or different and is group A or OR¹;
each hydrogen atom in R¹ and R² is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆ alkyl-N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃;
each R³ is selected from the group consisting of hydrogen, deuterium, —C₁—C₆ alkyl, —C₂—C₆ alkenyl, —C₂—C₆ alkynyl, —C₃—C₆ cycloalkyl, and —C₁—C₆ alkyl—O—C₁—C₆ alkyl, optionally substituted;
n is a positive integer; and
m is the same or different and is a positive integer greater than or equal to 2 and less than or equal to 20; and
curing the adhesion promoter to form the adhesion promoter layer.

34. The method of claim 33, wherein the adhesion promotor comprises a compound having a structure as Formula (II): 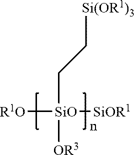
wherein:
each R¹ is the same or different and is a bond to another Si atom within the compound, or is selected from the group consisting of hydrogen, -C₁-C₆ alkyl, -C₂-C₆ alkenyl, and -C₃-C₆ alkynyl;
each hydrogen atom in R¹ is independently optionally substituted with deuterium, halogen, —OH, —CN, —OR³, —CO₂H, C(O)OR³, —C(O)NH₂, C(O)NH(C₁—C₆ alkyl), —C(O)N(C₁—C₆ alkyl)₂, SC₁—C₆ alkyl, S(O)C₁—C₆ alkyl, —S(O)₂C₁—C₆ alkyl, —S(O)NH(C₁—C₆ alkyl), —S(O)₂NH(C₁—C₆ alkyl), S(O)N(C₁C₆ alkyl)₂, —S(O)₂N(C₁—C₆ alkyl)₂, —NH₂, -NH(C₁—C₆ alkyl), —N(H)C₁—C₆ alkyl—NH₂, —N(H)C₁—C₆ alkyl—Si(—OC₁—C₆ alkyl)₃, —N(R³)C₁—C₆ alkyl—N(R³)C₁—C₆ alkyl—Si(—OC₁—C₆ alkyl)₃—N(H)C₁—C₆alkyl—N(H) C₁—C₆ alkyl—NH₂, —P(C₁—C₆ alkyl)₂, —P(O)(C₁—C₆ alkyl)₂,—PO₃H₂, or —Si(—OC₁—C₆ alkyl)₃;
each R³ is selected from the group consisting of hydrogen, deuterium, C₁—C₆ alkyl, C₂—C₆ alkenyl, C₂—C₆ alkynyl, C₃—C₆ cycloalkyl, and —C₁—C₆ alkyl—O—C₁—C₆ alkyl, optionally substituted; and
n is a positive integer.

35. The method of any one of claims 33-34, wherein the depositing step comprises spraying, dipping, wiping, chemical vapor deposition (CVD) or physical vapor deposition (PVD).

36. The method of any one of claims 33-35, wherein the substrate comprises a material selected from the group consisting of glass, a glass ceramic, a metal oxide, or a polymer.

37. The method of any one of claims 33-36, wherein the curing step comprises heating the adhesion promoter to a temperature between greater than or equal to 20° C. and less than or equal to 250° C.

38. The method of any one of claims 33-37, wherein the curing step is performed for a time between greater than or equal to 0.01 hours and less than or equal to 48 hours.

39. The method of any one of claims 33-38, wherein the adhesion promoter layer has a relative humidity of greater than or equal to 10%.

40. The method of any one of claims 33-39, further comprising activating the surface of the substrate by exposing the surface to a plasma of at least one gas selected from the group consisting of inert gases, N₂, O₂, and mixtures thereof.

41. The method of any one of claims 33-40, further comprising activating the surface of the substrate by mechanically treating the surface with a metal oxide or acid etching.

42. The method of any one of claims 33-41, wherein the compound is formed by polycondensing an organosilane compound in the presence of water and hydrosilylating the product of the polycondensation.
